(19) United States
(12) Patent Application Publication
(10) Pub. No.: US 2026/0300620 A1
(43) Pub. Date: Oct. 1, 2026

(54) Detecting Secretive Information in Large Language Model (LLM) Prompts

(71) Applicant: Zscaler, Inc., San Jose, CA (US)

(72) Inventors: Chenhui Hu, Boston, MA (US); Muhammed Salih, Bengaluru (IN); Sanjay Kalra, San Jose, CA (US)

(73) Assignee: Zscaler, Inc., San Jose, CA (US)

(21) Appl. No.: 19/092,170

(22) Filed: Mar. 27, 2025

(51) Int. Cl. G06F 40/279; G06F 21/62

(52) U.S. Cl. CPC G06F 40/279; G06F 21/6227

(57) ABSTRACT

Systems and methods described herein are configured to inspect prompts before they are transmitted to an external Large Language Model (LLM) chatbot or Generative Pre-trained Transformer (GPT). A method, according to one implementation, includes a step of intercepting a text-based prompt sent from a client device, the text-based prompt intended to be sent to an LLM chatbot. The method also includes analyzing the text-based prompt to determine whether one or more keywords exist therein. In response to detecting that one or more keywords exist in the text-based prompt, the method further includes a step of inspecting text surrounding the one or more keywords to determine whether one or more text segments include secretive information. In response to detecting that one or more text segments include secretive information, the method prevents leakage of the one or more text segments to the LLM chatbot while sending the text-based prompt.

### TECHNICAL FIELD

The present disclosure generally relates to cybersecurity in communications networks. More particularly, the present disclosure relates to systems and methods for detecting secretive information included within a Large Language Model (LLM) prompt in order to prevent the leakage of the secretive information to external networks.

### BACKGROUND

Large Language Models (LLMs), Generative Pre-trained Transformers (GPTs), chatbots, etc. have become popular over the past several years and may be useful for searching for solutions to specific problems, software development and coding, consolidating and skillfully describing knowledge of various topics, among other uses. Users are becoming more and more comfortable with these tools and may sometimes forget about the security implications of transmitting data (e.g., sensitive information) to unknown locations over unknown network infrastructures, whereby search prompts and queries are analyzed, and often stored, by unknown servers. In some cases, sensitive information may enter into environments that have a lesser extent of cybersecurity than the environment in which the prompt was initiated. Thus, sensitive data may be exposed to potentially environments that may be vulnerable to cyberattacks. There is therefore a need in the field of LLMs, GPTs, and chatbots to improve security policies with respect to inquiring about topics whereby sensitive, confidential, or secret data may be inadvertently incorporated into prompts in a search field and transmitted over the Internet.

### BRIEF SUMMARY

The present disclosure focuses on systems and methods configured to locally detect secretive information in an LLM prompt and respond accordingly in order to minimize exposure of the secretive information to the outside world. According to one implementation, a method includes a step of intercepting a text-based prompt sent from a client device, wherein the text-based prompt is intended to be sent to a Large Language Model (LLM) chatbot. The method further includes a step of analyzing the text-based prompt to determine whether one or more keywords exist therein. In response to detecting that one or more keywords exist in the text-based prompt, the method further includes a step of inspecting text surrounding the one or more keywords to determine whether one or more text segments include secretive information. In response to detecting that one or more text segments include secretive information, the method further includes a step of preventing leakage of the one or more text segments to the LLM chatbot while sending the text-based prompt.

In some embodiments, the step of inspecting the text surrounding the one or more keywords may include sub-steps of a) performing an entropy analysis to determine a randomness metric that characterizes an unpredictable string of characters, and b) performing a Markov chain analysis to determine a gibberish metric that characterizes a nonsensical, unintelligible, concocted, or fabricated string of characters. The step of inspecting the text surrounding the one or more keywords may further include a sub-step of c) combining the randomness metric and gibberish metric to determine whether the one or more text segments include secretive information. The sub-step of c) combining the randomness metric and gibberish metric, according to some embodiments, may further include plotting a point on a randomness-gibberish graph to determine if the point falls within an area that predicts that the one or more text segments include secretive information. In some implementations, the method may further include a step of adaptively modifying the randomness-gibberish graph based on characteristics of an enterprise in which the client device is operating.

According to some embodiments, the step of analyzing the text-based prompt to determine whether one or more keywords exist therein may further include a sub-step of searching the text-based prompt for text patterns that match one of a plurality of regular expression (regex) patterns or tokens targeting known secret formats, the plurality of regex patterns or tokens included in a predefined curated list. The predefined curated list of regex patterns or tokens, for example, may include at least “password,” “token,” “secret,” “auth,” “oauth,” “bearer,” and/or “api_key.”

The step of inspecting the text surrounding the one or more keywords, according to some implementations of the method, may include a sub-step of searching within a surrounding proximity window for random text and/or gibberish text suspected of being secretive information. The secretive information, for instance, may include one or more secrets regarding API keys, API tokens, password credentials, IP addresses, and email IDs. Also, for IP addresses and emails, the checking can be across the entire text, e.g., using regex.

In some embodiments, the method may further include a step of replacing the one or more text segments with one or more corresponding placeholders before sending the text-based prompt to the LLM chatbot. Upon receiving a response from the LLM chatbot, the method may further include a step of replacing the one or more corresponding placeholders with the one or more text segments before sending the response to the client device. Alternatively, the method may also include a step of redacting the one or more text segments or secretive information before sending the text-based prompt to the LLM chatbot.

Additionally, the method may further include steps of a) logging information regarding detection of the secretive information and corresponding metadata; and b) generating an alert to notify a network administrator of the secretive information and corresponding metadata. The step of preventing leakage, for example, may be configured to decrease a potential attack surface of an enterprise in which the client device is operating.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a query system for allowing a user to request an answer of a query from a Large Language Model (LLM) server, according to various embodiments.

FIG. 2 is a block diagram illustrating a computing system of the prompt analyzing device shown in FIG. 1, according to various embodiments.

FIG. 3 is a graph illustrating a threshold curve with respect to randomness and gibberish metrics, according to various embodiments.

FIG. 4 is a flow diagram illustrating a method for detecting secretive information in an LLM prompt, according to various embodiments.

### DETAILED DESCRIPTION

A prompt that is used in a chatbot query would normally be transmitted directly to a remote search engine or LLM server. Then, the LLM server would reply with an appropriate response. However, this conventional methodology, in some cases, may increase the attack surface of an organization and can give a hacker a greater likelihood of stealing sensitive information, which, of course, can be detrimental to the organization in some cases. To overcome the issues with conventional methods, the present disclosure is directed to systems and methods for ensuring that sensitive information is not transmitted (e.g., intentionally or unintentionally) across communications systems having questionable security policies.

### Query System

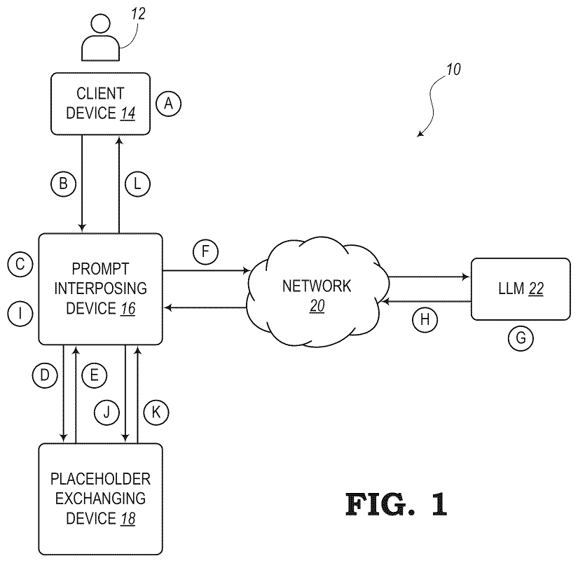

FIG. 1 is a block diagram illustrating an embodiment of a query system 10 for allowing a user 12 to enter a query request and receive an answer from a Large Language Model (LLM) server. As shown in FIG. 1, the query system 10 allows the user 12 to enter a query or search in a client device 14 (e.g., end user device, computer, mobile device, etc.), where the user 12 may be associated with (e.g., employed by) an enterprise (e.g., organization, business, university, etc.) and the client device 14 may be registered, deployed, and/or operating within the enterprise. The user 12 may enter a prompt into a search field of the client device 14 for inquiring about any type of information.

Normally, a prompt may be transmitted directly to a remote search engine or LLM server, which may then reply with an appropriate response. However, this conventional methodology, in some cases, may increase the attack surface of the enterprise, thereby allowing a malicious actor (e.g., hacker) to have a greater likelihood of obtaining sensitive information and wreaking havoc upon the enterprise. The query system 10, according to the descriptions in the present disclosure, is configured to overcome this shortcoming of the conventional systems by ensuring that sensitive information is not transmitted (e.g., unwittingly) across less secure communications infrastructures.

Thus, the query system 10 further includes a prompt interposing device 16 that is interposed between the client device 14 and a communications network 20 (e.g., the Internet). The query system 10, in some embodiments, may further include a placeholder exchanging device 18 that works in conjunction with the prompt interposing device 16. Therefore, if sensitive information is detected by the prompt interposing device 16, the placeholder exchanging device 18 may be enacted to substitute the sensitive information with arbitrary placeholder information. For example, the placement exchanging device 18 may include data storage for storing corresponding pairs of secrets and placeholders. In this way, when the prompt is transmitted to an LLM 22 (e.g., LLM server, cloud-based search engine, etc.) via the network 20, the sensitive information is blocked from being spread to unknown regions of the Internet.

According to various embodiments of the present disclosure, the sensitive information (or confidential data) of particular interest may be related to certain “secrets,” such as Application Programming Interface (API) keys, API tokens, password credentials, IP addresses, email ID information, etc. In one use case, for instance, the user 12 may copy a block of text from a specific source and paste it into the search field as a prompt, perhaps unaware that this block of text might include one or more secrets (e.g., the user's email address). The prompt interposing device 16 is configured to act as a filter or firewall-type component for ensuring that the secret information is not carried over the network 20 to the LLM 22, where it may be stored indefinitely or referenced in searches by other users.

For security purposes, the prompt interposing device 16 is configured to filter the search prompts from the client device 14 (or prompts from multiple user devices in the enterprise). The prompt interposing device 16 is also configured to inspect or analyze the prompts for sensitive information and/or specific keywords that may be indicative of proximate secrets within the block of text. For example, these keywords may include “secret,” “password,” “token,” “auth,” and/or other words, phrases, abbreviations, etc. If one or more secrets are found within a certain number of characters from the keywords, these secrets can be flagged for removal, replacement, blocking, obfuscation, etc. The prompts (with any secrets blocked or removed) can then be sent to the LLM 22 to continue with the search. By blocking the secrets, the prompt interposing device 16 is configured to limit the exposure of sensitive data (e.g., secrets) within potentially less secure environments.

The operation of the query system 10, according to various embodiments, may include the following steps:
A) The user 12 uses the client device 14 to enter a text-based prompt.
B) The client device 14 sends the prompt over an internal secure link (e.g., within an enterprise domain) to the prompt interposing device 16, which intercepts the prompt before it is sent to the LLM 22.
C) The prompt interposing device 16 is configured to inspect the prompt for secrets. In some embodiments, the secrets may simply be removed from the prompt or otherwise blocked. Also, if no secrets are found, the prompt can be transmitted over the network 20 to the LLM 22.
D) Regarding embodiments in which secrets are discovered and it is the intention of the enterprise to “sanitize” the prompt, the prompt interposing device 16 is configured to pass a list of the itemized secrets to the placeholder exchanging device 18;
E) In response to receiving the secrets, the placeholder exchanging device 18 is configured to replace the secrets with placeholders (e.g., replacing password “NYC_anna_975_CATS!” with “$$secret #001,” replacing random machine-generated code “f5L6!s?9%2” with “$$secret #002, etc.). Next, the placeholder exchanging device 18 is configured to return these placeholders back to the prompt interposing device 16 in order that the prompt interposing device 16 can replace the secrets with the corresponding placeholders in an effort to prevent leakage of the secrets outside of the secure enterprise network.
F) The prompt interposing device 16 is configured to transmit the prompt (with the secrets blocked, replaced, or otherwise secured) to the LLM 22 via the network 20.
G) The LLM 22 receives the prompt, stores the prompt in short-term memory as needed, searches available databases for answers to the prompt, etc.
H) The LLM 22 sends the response back to the prompt interposing device 16 via the network 20.
I) The prompt interposing device 16 is configured to review the response to determine what to do next. If no placeholders had been used, the response or answer can be forwarded to the client device 14.
J) Otherwise, if placeholders had been used, the prompt interposing device 16 may send the placeholders to the placeholder exchanging device 18.
K) The placeholder exchanging device 18 is configured to retrieve the corresponding secret from memory and put the secret back into its proper context based on the location of the associated placeholders included in the response. The prompt interposing device 16 is then configured to put the secrets back into the answer.
L) Then, the prompt interposing device 16 is configured to send the response (with the secrets reinserted) to the client device 14.

Since the query system 10 is configured to prevent the leakage of secrets outside the secure environment of the enterprise network (i.e., lefthand side of FIG. 1), the attack surface is reduced (or is not enlarged) as a result of sensitive or secretive information being entered into a prompt.

### Prompt Interposing Device

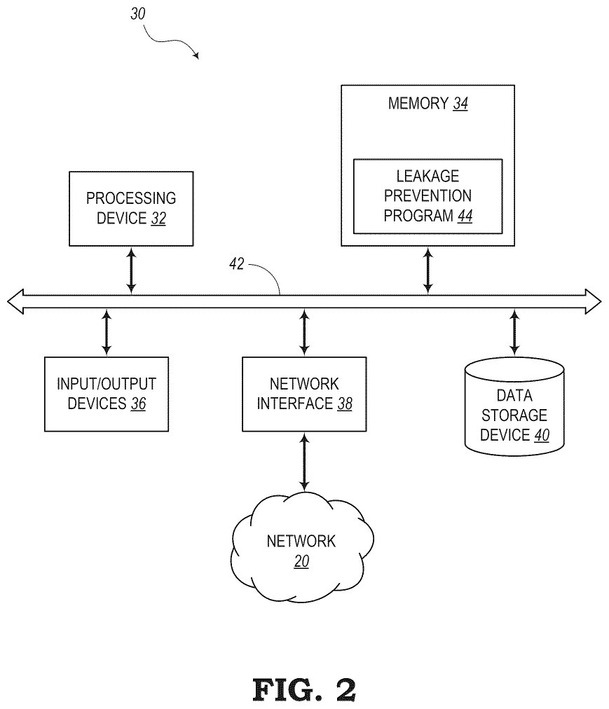

FIG. 2 is a block diagram illustrating an embodiment of a computing system 30 associated with the prompt interposing device 16 shown in FIG. 1. In this embodiment, the computing system 30 includes a processing device 32 (e.g., one or more processors), memory 34 (or memory device), input/output devices 36 (or peripheral devices), a network interface 38, and a data storage device 40 (or database), each interconnected with each other via a local interface 42 (or bus). The computing system 30 further includes a leakage prevention program 44, which may be implemented in any suitable combination of software and/or hardware. The leakage prevention program 44 may be stored in non-transitory computer-readable media and may have computing logic or instructions that enable or cause the processing device 32 to perform specific functions related to the inspecting and filtering of prompts before they are sent to a remote LLM server.

It should be appreciated that the processing device 32, according to some embodiments, may include or utilize one or more generic or specialized processors (e.g., microprocessors, CPUs, Digital Signal Processors (DSPs), Network Processors (NPs), Network Processing Units (NPUs), Graphics Processing Units (GPUs), Field Programmable Gate Arrays (FPGAs), semiconductor-based devices, chips, and the like). The processing device 32 may also include or utilize stored program instructions (e.g., stored in hardware, software, and/or firmware) for control of the computing system 30 by executing the program instructions to implement some or all of the functions of the systems and methods described herein. Alternatively, some or all functions may be implemented by a state machine that may not necessarily include stored program instructions, may be implemented in one or more Application Specific Integrated Circuits (ASICs), and/or may include functions that can be implemented as custom logic or circuitry. Of course, a combination of the aforementioned approaches may be used. For some of the embodiments described herein, a corresponding device in hardware (and optionally with software, firmware, and combinations thereof) can be referred to as “circuitry” or “logic” that is “configured to” or “adapted to” perform a set of operations, steps, methods, processes, algorithms, functions, techniques, etc., on digital and/or analog signals as described herein with respect to various embodiments.

The memory 34 may include volatile memory elements (e.g., Random Access Memory (RAM), Dynamic RAM (DRAM), Synchronous DRAM (SDRAM), Static RAM (SRAM), and the like), nonvolatile memory elements (e.g., Read Only Memory (ROM), Programmable ROM (PROM), Erasable PROM (EPROM), Electrically-Erasable PROM (EEPROM), hard drive, tape, Compact Disc ROM (CD-ROM), and the like), or combinations thereof. Moreover, the memory 34 may incorporate electronic, magnetic, optical, and/or other types of storage media. The memory 34 may have a distributed architecture, where various components are situated remotely from one another, but can be accessed by the processing device 32.

The memory 34 may include a data store, database (e.g., data storage device 40), or the like, for storing data. In one example, the data store may be located internal to the computing system 30 and may include, for example, an internal hard drive connected to the local interface 42 in the computing system 30. Additionally, in another embodiment, the data store may be located externally to the computing system 30 and may include, for example, an external hard drive connected to the input/output devices 36 (e.g., SCSI or USB connection). In a further embodiment, the data store may be connected to the computing system 30 through a network and may include, for example, a network attached file server.

Software stored in the memory 34 may include one or more computer programs, each of which may include an ordered listing of executable instructions for implementing logical functions. The software in the memory 34 may also include a suitable Operating System (O/S). The O/S essentially controls the execution of other computer programs, and provides scheduling, input/output control, file and data management, memory management, and communication control and related services. The computer programs may be configured to implement the various processes, algorithms, methods, techniques, etc. described herein.

Moreover, some embodiments may include non-transitory computer-readable media having instructions stored thereon for programming or enabling a computer, server, processor (e.g., processing device 32), circuit, appliance, device, etc. to perform functions as described herein. Examples of such non-transitory computer-readable medium may include a hard disk, an optical storage device, a magnetic storage device, a ROM, a PROM, an EPROM, an EEPROM, Flash memory, and the like. When stored in the non-transitory computer-readable medium, software can include instructions executable (e.g., by the processing device 32 or other suitable circuitry or logic). For example, when executed, the instructions may cause or enable the processing device 32 to perform a set of operations, steps, methods, processes, algorithms, functions, techniques, etc. as described herein according to various embodiments.

The methods, sequences, steps, techniques, and/or algorithms described in connection with the embodiments disclosed herein may be embodied directly in hardware, in software/firmware modules executed by a processor (e.g., processing device 32), or any suitable combination thereof. Software/firmware modules may reside in the memory 34, memory controllers, Double Data Rate (DDR) memory, RAM, flash memory, ROM, PROM, EPROM, EEPROM, registers, hard disks, removable disks, CD-ROMs, or any other suitable storage medium.

Those skilled in the pertinent art will appreciate that various embodiments may be described in terms of logical blocks, modules, circuits, algorithms, steps, and sequences of actions, which may be performed or otherwise controlled with a general purpose processor, a DSP, an ASIC, an FPGA, programmable logic devices, discrete gates, transistor logic, discrete hardware components, elements associated with a computing device, controller, state machine, or any suitable combination thereof designed to perform or otherwise control the functions described herein.

The I/O devices 36 may be used to receive user input from and/or for providing system output to one or more devices or components. For example, user input may be received via one or more of a keyboard, a keypad, a touchpad, a mouse, and/or other input receiving devices. System outputs may be provided via a display device, monitor, User Interface (UI), Graphical User Interface (GUI), a printer, and/or other user output devices. I/O devices 36 may include, for example, one or more of a serial port, a parallel port, a Small Computer System Interface (SCSI), an Internet SCSI (iSCSI), an Advanced Technology Attachment (ATA), a Serial ATA (SATA), a fiber channel, InfiniBand, a Peripheral Component Interconnect (PCI), a PCI extended interface (PCI-X), a PCI Express interface (PCIe), an InfraRed (IR) interface, a Radio Frequency (RF) interface, and a Universal Serial Bus (USB) interface.

The network interface 38 may be used to enable the computing system 30 to communicate over a network, such as the network 20, the Internet, a Wide Area Network (WAN), a Local Area Network (LAN), and the like. The network interface 38 may include, for example, an Ethernet card or adapter (e.g., 10BaseT, Fast Ethernet, Gigabit Ethernet, 10 GbE) or a Wireless LAN (WLAN) card or adapter (e.g., 802.11a/b/g/n/ac). The network interface 38 may include address, control, and/or data connections to enable appropriate communications on the network 20.

### Graph Combining Randomness and Gibberish Metrics

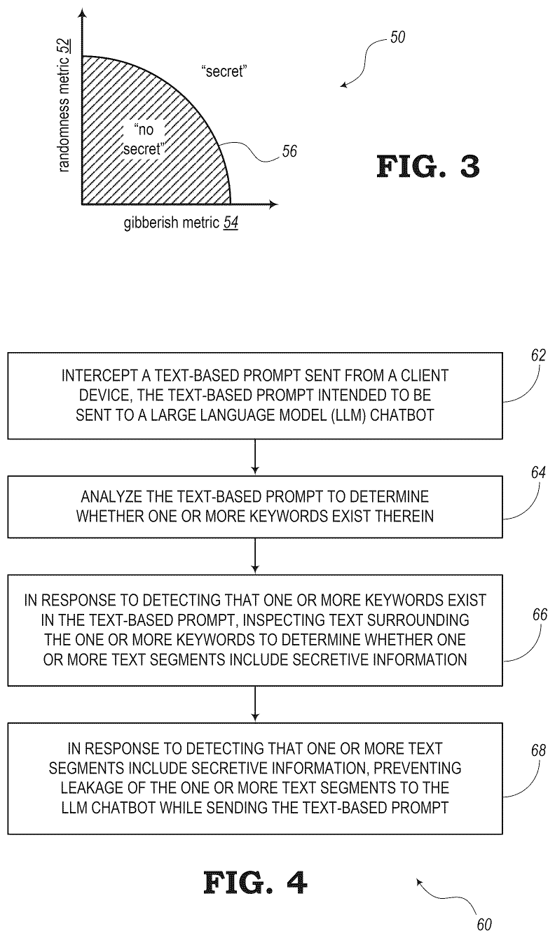

FIG. 3 shows an example of a randomness-gibberish graph 50 used to predict whether a text segment contains secretive information or not. The randomness-gibberish graph 50 includes a randomness metric 52 on one axis and a gibberish metric 54 on another axis. Also, a threshold curve 56 is positioned on the randomness-gibberish graph 50 to separate between a prediction of “no secret” and “secret,” whereby points beyond the threshold curve 56 (i.e., sufficient randomness and/or gibberish) are considered to be indicative of secretive information. In other words, any significant measure of randomness and/or gibberish indicates a prediction of the existence of secretive information in the text segment.

Therefore, a text segment can be analyzed according to a randomness detection model (e.g., entropy detection) for calculating the randomness metric 52. Also, the text segment can be analyzed according to a gibberish detection model (e.g., Markov chain detection) for calculating the gibberish metric 54. These two metrics can be plotted as a point on the randomness-gibberish graph 50. If the point falls below the threshold curve 56 (i.e., in the shaded area), the associated text segment being measured is predicted to have “no secrets” or no secretive information. Otherwise, if the point falls above the threshold curve 56, the associated text segment being measured is predicted to have a “secret” or secretive information.

In some embodiments, the threshold curve 56 can be modified universally for general use by multiple organizations and can also be customized in a suitable manner for each individual organization based on various data usage policies thereof. Additionally, the threshold curve 56 can be a line segment in some cases or may include any suitable shape.

Method for Handling Secretive Information included in a Prompt

FIG. 4 is a flow diagram illustrating an embodiment of a method 60 for detecting secretive information in an LLM prompt and preventing leakage of the secretive information to external network environments. As shown in the embodiment of FIG. 4, the method 60 includes a step of intercepting a text-based prompt sent from a client device, as indicated in block 62, wherein the text-based prompt is intended to be sent to a Large Language Model (LLM) chatbot. The method 60 further includes a step of analyzing the text-based prompt to determine whether one or more keywords exist therein, as indicated in block 64. In response to detecting that one or more keywords exist in the text-based prompt, the method 60 further includes a step of inspecting text surrounding the one or more keywords to determine whether one or more text segments include secretive information, as indicated in block 66. In response to detecting that one or more text segments include secretive information, the method 60 further includes a step of preventing leakage of the one or more text segments to the LLM chatbot while sending the text-based prompt, as indicated in block 68.

In some embodiments, the step of inspecting the text surrounding the one or more keywords (block 66) may include sub-steps of a) performing an entropy analysis to determine a randomness metric that characterizes an unpredictable string of characters, and b) performing a Markov chain analysis to determine a gibberish metric that characterizes a nonsensical, unintelligible, concocted, or fabricated string of characters. The step of inspecting the text surrounding the one or more keywords (block 66) may further include a sub-step of c) combining the randomness metric and gibberish metric to determine whether the one or more text segments include secretive information. The sub-step of c) combining the randomness metric and gibberish metric, according to some embodiments, may further include plotting a point on a randomness-gibberish graph to determine if the point falls within an area that predicts that the one or more text segments include secretive information. In some implementations, the method 60 may further include a step of adaptively modifying the randomness-gibberish graph based on characteristics of an enterprise in which the client device is operating.

According to some embodiments, the step of analyzing the text-based prompt to determine whether one or more keywords exist therein (block 64) may further include a sub-step of searching the text-based prompt for text patterns that match one of a plurality of regular expression (regex) patterns or tokens targeting known secret formats, the plurality of regex patterns or tokens included in a predefined curated list. The predefined curated list of regex patterns or tokens, for example, may include at least “password,” “token,” “secret,” “auth,” “oauth,” “bearer,” and/or “api_key.”

The step of inspecting the text surrounding the one or more keywords (block 66), according to some implementations of the method 60, may include a sub-step of searching within a surrounding proximity window for random text and/or gibberish text suspected of being secretive information. The secretive information, for instance, may include one or more secrets regarding API keys, API tokens, password credentials, IP addresses, and email IDs.

In some embodiments, the method 60 may further include a step of replacing the one or more text segments with one or more corresponding placeholders before sending the text-based prompt to the LLM chatbot. Upon receiving a response from the LLM chatbot, the method 60 may further include a step of replacing the one or more corresponding placeholders with the one or more text segments before sending the response to the client device. Alternatively, the method 60 may also include a step of redacting the one or more text segments or secretive information before sending the text-based prompt to the LLM chatbot.

Additionally, the method 60 may further include steps of a) logging information regarding detection of the secretive information and corresponding metadata; and b) generating an alert to notify a network administrator of the secretive information and corresponding metadata. The step of preventing leakage (block 68), for example, may be configured to decrease a potential attack surface of an enterprise in which the client device is operating.

### Additional Considerations

According to some embodiments of the systems and methods of the present disclosure, the prompt interposing device 16 (and/or placeholder exchanging device 18) may be configured in any suitable network access framework that may be running in the enterprise network. In some respects, the prompt interposing device 16 and placeholder exchanging device 18 may be combined together as one product, which may be referred to as a “prompt sanitizing system.” The prompt sanitizing system may be configured for performing prompt filtering and security to limit exposure of potentially sensitive data (e.g., secrets) in external systems (e.g., outside the domain of the enterprise). In some embodiments, the prompt sanitizing system may be incorporated with a search program or application allowing users to search for answers to a variety of queries from LLM service components that may be located externally or remotely with respect to the enterprise.

In some embodiments, the search platform or query system 10 may include any front end component for interfacing with a user device (e.g., client device 14) for communication with a back end LLM system. The secrets described in the present disclosure may include passwords, user credentials, IP addresses, API keys, API tokens, etc. Also, other sensitive or confidential information may be filtered, sanitized, replaced, etc., according to other implementations, for the purpose of Data Loss Prevention (DLP).

Thus, the systems and methods of the present disclosure are configured to prevent the leaking of secrets to an LLM, which can be problematic for a number of reasons. In one sense, it may be difficult (or impossible in some cases) to maintain control of sensitive information the moment it leaves a secure environment of a well-protected enterprise network. Once a prompt leaves home, it enters the big, bad world of potentially unsecured communications equipment/policies and may encounter hackers who can exploit the innocent prompt. In short, leaking secrets to an LLM puts the secrets in an environment that a client does not fully control, creating security, compliance, and confidentiality risks.

Other concerns may also include:
1. Permanent Storage and Possible Retention—many LLMs or their backend services may log user prompts (even if only temporarily). A secret that enters into an LLM could remain on the service provider's servers, become part of an internal dataset, or accidentally be stored in query logs.
2. Potential for Unauthorized Access—If those logs or internal datasets are ever compromised, an attacker can steal API keys, passwords, or other credentials. Even if the provider's security is robust, there is still an increased attack surface when sensitive data is in someone else's infrastructure.
3. Breach of Confidentiality—Some providers may use prompts for model improvement (unless a client opts out). This means that the client's secrets could be used in further training, risking indirect disclosure to other users or surfacing in model outputs under certain conditions.
4. Regulatory and Compliance Issues—Industries handling personal data (healthcare, finance, etc.) are bound by strict regulations (HIPAA, GDPR, etc.). Sharing regulated data with an LLM without proper safeguards could lead to regulatory non-compliance and legal consequences.
5. Unintended Wider Distribution—If the LLM or any integrated system logs or caches queries for debugging, monitoring, or customer support, a user's secrets might be visible to additional internal teams or services beyond an organization's immediate control.
6. Re-exposure or “Hallucination”—LLMs sometimes “hallucinate” or regurgitate previously ingested content. If an LLM has somehow retained a leaked secret, there is a possibility—albeit small—it could reappear in another user's output or in a future query.

Overall, the solutions described herein strike a practical balance between thorough scanning for “known” secret patterns and detecting arbitrary or unique credentials, while keeping false positives low and offering easy integration into existing LLM workflows. The following are advantages of the proposed multi-level secret-detection solution for LLM prompts:
1. Comprehensive Coverage—Regex for Known Patterns can quickly catch recognizable secrets like AWS, GCP, or OAuth tokens using curated regular expressions. Contextual & Entropy Checks can identify more obscure or company-specific secrets by analyzing surrounding keywords (e.g., “password,” “token”) and testing strings for randomness/gibberish. Also, with Adaptive Thresholds, the dual-layer approach (entropy/random detection+Markov chain/gibberish detection) ensures the system can flexibly capture both highly random strings and slightly less-random credentials.
2. Reduced False Positives—With Two-Tier Verification, a string passes both the entropy/gibberish tests (or meet context criteria) to be flagged, minimizing accidental blocking of legitimate text. With Contextual Narrowing, by only scanning near keywords like “secret,” “auth,” or “password,” the solution avoids over-checking irrelevant parts of the prompt.
3. Easy Integration & Real-Time Blocking—A Layered Architecture of the query system 10 can act as a front-end filter before prompts reach the LLM, preventing leaks in real time. Also, the systems and methods may use an Offline Option, wherein, alternatively, logs or historical data can be scanned to detect leaks after the fact (e.g., for compliance or audit). Another aspect is that a client (or enterprise) does not need to know the secrets to detect them. In other words, there is no need for establishing a pre-defined dictionary before the system can be used.

Again, “secrets” may include a) API keys and tokens (e.g., AWS-style credential formats), b) password credentials embedded in text, c) IP addresses and email addresses (e.g., Personally Identifiable Information (PII)-type data), etc., with a potential to expand to additional sensitive data in the future (e.g., other PII, proprietary codes).

The systems and methods of the present disclosure provide a Multi-Layer Detection Strategy including, for example, a) Regex-Based Scanning and b) Contextual & Entropy Checks. Regex-Based Scanning, for instance, may be a first layer that uses a curated set of regular expressions for well-known secret formats (e.g., AWS tokens, standard email/IP regex checks). It can detect “known” patterns quickly (e.g., AWS_ABC . . . , typical password patterns, etc.).

The Contextual & Entropy Checks may involve Contextual Clues. If keywords like “password,” “oauth,” or “token” appear, the system scans a surrounding window (e.g., ±40 characters) for suspicious strings. This may also include Dual-Layer Analysis of extracted strings, such as 1) Entropy Measurement-High-entropy strings are more likely random machine-generated secrets, and 2) Gibberish Detection via Markov Chains: Flags text fragments that are nonsensical (likely auto-generated credentials). The systems may be configured to apply adaptive thresholds (e.g., if the Markov chain model indicates “gibberish,” a lower entropy threshold may suffice to flag a secret, reducing false positives).

According to some embodiments, the systems may be envisioned as an intercept layer between the user's browser/interface and the LLM endpoint. If the system detects secrets, it can block or redact them before the prompt is forwarded, preventing inadvertent credential exposure. Also, it can be run offline for audit/analysis if real-time blocking is not required.

In addition, the systems and methods of the present disclosure have been tested using datasets. In the results of the Evaluation & Test Data, it was found that Email & IP Detection achieved near-perfect results using publicly available test sets. Also, for API Keys & Tokens, no standard public dataset was available, so a testing team created a synthetic test set with ~1,000 samples. Using this synthetic dataset, a GPT was used to generate “prompt templates” and inserted random secret-like strings to simulate real-world scenarios. The results achieved high F1 scores, confirming the system's effectiveness in detecting synthetic secrets.

Regarding the evaluation results while testing the models of the present disclosure, it was found that for email IDs and IP addresses, samples from a PII dataset were used to evaluate the system. For API tokens/keys, GPT was used to come up with a set of positive samples (1000) and a randomly sampled set from ShareGPT was used as negative samples. F1 scores in different categories of the test dataset include a) 0.998 for email IDs, b) 0.985 for IP addresses, and c) 0.900 for API tokens/keys, which demonstrates the effectiveness of the systems and methods described herein.

Also, sample prompts were used for data generation and for testing the solutions described herein. In this case, the test included generating 50 diverse examples of LLM user messages/prompts that include an API token or key, using the placeholder $$secret in place of the actual key. The messages simulated realistic scenarios where someone might share an API key or token, including both code snippets and text messages. Also, the sample prompt included examples from various programming languages and contexts and ensured that the messages varied in style and content. Again, the test results showed effective filtering of prompts having secrets.

The present disclosure provides certain advantages over conventional systems to provide unique innovations that reduce the attack surface of a client's system. By interposing a prompt analysis device between the user's browser and the LLM back end server, it is possible to nip any security issues in the bud by filtering out secrets before they are transmitted arbitrarily over the World Wide Web. Thus, the interposed device can intercept the prompt an in initial stage to inspect, check, or analyze the prompt for the existence of one or more secrets, and then filter, sanitize, replace, or secure the secrets to prevent leakage of these secrets, which may be caused by carelessness, inexperience, and/or inadvertent copy and paste actions, and can even be caused by indifference and/or malicious intent.

Another advantage over conventional systems is an Adaptive Two-Tier Check (e.g., using Entropy+Markov Chain) to identify a wide variety of random/obfuscated secrets. The systems and methods of the present disclosure also feature Contextual Windowing around known secret-related keywords to reduce scanning overhead and focus on probable insertion points. Furthermore, the present disclosure is beneficial in that it introduces an Integration with Regex Patterns for well-known providers (AWS, GCP, etc.) while remaining flexible to detect non-standard “company-specific” secrets. Thus, the systems and methods described herein provide a robust, layered mechanism for detecting and preventing the leakage of sensitive information in LLM prompts. By combining pattern-based checks with statistical/entropy methods and contextual analyses, the system minimizes false positives while reliably capturing genuinely risky secrets.

Therefore, the present disclosure is configured to a) detect sensitive information and secrets within prompts sent to LLM chatbots automatically, b) enforce security policies and prevent accidental exposure of credentials, and c) support multiple secret types including API keys, tokens, credentials, IP addresses and email IDs. The embodiments described in the present disclosure include intelligent secret detection systems and methods that combine multiple detection strategies, including a) pattern matching using carefully curated regex patterns, b) entropy (randomness) calculation+Markov chain (gibberish) detection for identifying machine-generated and concocted/fabricated secrets, c) encoded secrets detection with keyword context analysis.

According to one innovation, the present disclosure may include an Adaptive Encoded Secret Detection, including, for instance, a) context-aware detection of encoded secrets, b) keyword-based proximity analysis using a list of keywords, c) variable-length window scanning (e.g., up to about 40 characters) for possible secrets and then potential candidates passes through a few checks. For example, a keyword list may include “password,” “passwd,” “auth,” “oauth,” “bearer,” “secret,” “api_key,” “api_token,” and/or any other commonly used or business specific keywords.

According to another innovation, the present disclosure may include a Dual-Layer Detection of Random Strings, including, for instance:
A) a Primary Layer defined by a Randomness Detection using Entropy Analysis, which may be configured to measure how random or unpredictable a string of characters is. For example, a high degree of randomness can indicate that the text segment is likely machine-generated secrets, especially where 1) characters appear in no natural pattern, 2) looks like a jumble of letters, numbers, and symbols, 3) typical of API keys and authentication tokens, or the like.
B) a Secondary Layer defined by a Gibberish Detection (e.g., using Markov chain analysis). This can work in conjunction with the entropy/randomness analysis, so as to identify strings that appear to be concocted by a human using unconventional patterns and associations, such as nicknames, pet's name, numbers special to the user (e.g., birthday, birth month, etc.), etc. Also, this can be used by an already existing package with a model trained on the default dataset provided in the gibberish detection package.

The benefits of the Dual-Layer Approach, for example, may include at least a reduction in false positives compared to single-signal detection. The Dual-Layer Approach can also provide protection against novel secret patterns

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as described in the present disclosure. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A method comprising steps of:
intercepting a text-based prompt sent from a client device, the text-based prompt intended to be sent to a Large Language Model (LLM) chatbot;
analyzing the text-based prompt to determine whether one or more keywords exist therein;
in response to detecting that one or more keywords exist in the text-based prompt, inspecting text surrounding the one or more keywords to determine whether one or more text segments include secretive information; and
in response to detecting that one or more text segments include secretive information, preventing leakage of the one or more text segments to the LLM chatbot while sending the text-based prompt.

2. The method of claim 1, wherein the step of inspecting the text surrounding the one or more keywords includes sub-steps of:
a) performing an entropy analysis to determine a randomness metric that characterizes an unpredictable string of characters; and
b) performing a Markov chain analysis to determine a gibberish metric that characterizes a nonsensical, unintelligible, concocted, or fabricated string of characters.

3. The method of claim 2, wherein the step of inspecting the text surrounding the one or more keywords further includes a sub-step of combining the randomness metric and gibberish metric to determine whether the one or more text segments include secretive information.

4. The method of claim 3, wherein the sub-step of combining the randomness metric and gibberish metric includes plotting a point on a randomness-gibberish graph to determine if the point falls within an area that predicts that the one or more text segments include secretive information.

5. The method of claim 4, further comprising a step of adaptively modifying the randomness-gibberish graph based on characteristics of an enterprise in which the client device is operating.

6. The method of claim 1, wherein the step of analyzing the text-based prompt to determine whether one or more keywords exist therein includes a sub-step of searching the text-based prompt for text patterns that match one of a plurality of regular expression (regex) patterns or tokens targeting known secret formats, the plurality of regex patterns or tokens included in a predefined curated list.

7. The method of claim 6, wherein the predefined curated list includes one or more of “password,” “token,” “secret,” “auth,” “oauth,” “bearer,” and “api_key.”

8. The method of claim 1, wherein the step of inspecting the text surrounding the one or more keywords includes a sub-step of searching within a surrounding proximity window for random text and/or gibberish text suspected of being secretive information.

9. The method of claim 1, wherein the secretive information includes one or more secrets regarding API keys, API tokens, password credentials, IP addresses, and email IDs.

10. The method of claim 1, further comprising a step of replacing the one or more text segments with one or more corresponding placeholders before sending the text-based prompt to the LLM chatbot.

11. The method of claim 10, wherein, upon receiving a response from the LLM chatbot, the method further comprises a step of replacing the one or more placeholders with the corresponding one or more text segments before sending the response to the client device.

12. The method of claim 1, further comprising a step of redacting the one or more text segments or secretive information before sending the text-based prompt to the LLM chatbot.

13. The method of claim 1, further comprising steps of:
a) logging information regarding detection of the secretive information and corresponding metadata; and
b) generating an alert to notify a network administrator of the secretive information and corresponding metadata.

14. The method of claim 1, wherein the step of preventing leakage is configured to decrease a potential attack surface of an enterprise in which the client device is operating.

15. A system comprising:
a processing device; and
a memory device configured to store a computer program having instructions that, when executed, enable the processing device to
intercept a text-based prompt sent from a client device, the text-based prompt intended to be sent to a Large Language Model (LLM) chatbot,
analyze the text-based prompt to determine whether one or more keywords exist therein,
in response to detecting that one or more keywords exist in the text-based prompt, inspect text surrounding the one or more keywords to determine whether one or more text segments include secretive information, and
in response to detecting that one or more text segments include secretive information, prevent leakage of the one or more text segments to the LLM chatbot while sending the text-based prompt.

16. The system of claim 15, wherein the instructions enable the processing device to inspect the text surrounding the one or more keywords by:
a) performing an entropy analysis to determine a randomness metric that characterizes an unpredictable string of characters; and
b) performing a Markov chain analysis to determine a gibberish metric that characterizes a nonsensical, unintelligible, concocted, or fabricated string of characters.

17. The system of claim 16, wherein the instructions enable the processing device to inspect the text surrounding the one or more keywords by combining the randomness metric and gibberish metric to determine whether the one or more text segments include secretive information, whereby combining the randomness metric and gibberish metric includes plotting a point on a randomness-gibberish graph to determine if the point falls within an area that predicts that the one or more text segments include secretive information.

18. The system of claim 15, wherein the instructions enable the processing device to analyze the text-based prompt to determine whether one or more keywords exist therein by searching the text-based prompt for text patterns that match one of a plurality of regular expression (regex) patterns or tokens targeting known secret formats, the plurality of regex patterns or tokens included in a predefined curated list including one or more of “password,” “token,” “secret,” “auth,” “oauth,” “bearer,” and “api_key.”

19. A non-transitory computer-readable medium configured to store computer logic having instructions that, when executed, cause one or more processing devices to:
intercept a text-based prompt sent from a client device, the text-based prompt intended to be sent to a Large Language Model (LLM) chatbot;
analyze the text-based prompt to determine whether one or more keywords exist therein;
in response to detecting that one or more keywords exist in the text-based prompt, inspect text surrounding the one or more keywords to determine whether one or more text segments include secretive information; and
in response to detecting that one or more text segments include secretive information, prevent leakage of the one or more text segments to the LLM chatbot while sending the text-based prompt.

20. The non-transitory computer-readable medium of claim 19, wherein the instructions further cause the one or more processing devices to:
replace the one or more text segments with one or more corresponding placeholders before sending the text-based prompt to the LLM chatbot; and
upon receiving a response from the LLM chatbot, replace the one or more placeholders with the corresponding one or more text segments before sending the response to the client device.
